(19) United States
(12) Patent Application Publication
(10) Pub. No.: US 2013/0141720 A1
(43) Pub. Date: Jun. 6, 2013

(54) PLASMA DIAGNOSTIC APPARATUS AND METHOD

(71) Applicant: Samsung Electronics Co., Ltd., Suwon-Si (KR)

(72) Inventors: Ho Yong PARK, Hwaseong-si (KR); Valdimir VOLYNETS, Suwon-si (KR); Vladimir PROTOPOPOV, Suwon-si (KR); Sang Heon LEE, Seongnam-si (KR); Sung Ho JANG, Suwon-si (KR); Sang Jean JEON, Hwaseong-si (KR)

(73) Assignee: SAMSUNG ELECTRONICS CO., LTD., Suwon-Si (KR)

(21) Appl. No.: 13/690,177

(22) Filed: Nov. 30, 2012

(30) Foreign Application Priority Data
Dec. 5, 2011 (KR) 10-2011-0129237

(51) Int. Cl. G01J 3/443

(52) U.S. Cl. CPC G01J 3/443
USPC 356/316

(57) ABSTRACT

A plasma diagnostic apparatus includes a vacuum chamber unit having at least one electrode and having plasma generated inside. A bias power unit is disposed inside the vacuum chamber unit to apply a radio frequency voltage to an electrode that supports a wafer. A spectrum unit decomposes light emitted from inside the plasma according to wavelengths. A light detection unit detects the light decomposed according to wavelengths. A control unit controls a turn-on and turn-off process of the light detection unit according to a waveform of the radio frequency voltage.

### CROSS-REFERENCE TO RELATED APPLICATION

This application claims the benefit of Korean Patent Application No. 2011-0129237, filed on Dec. 5, 2011 in the Korean Intellectual Property Office, the disclosure of which is incorporated in its entirety herein by reference.

### BACKGROUND

1. Field

Example embodiments of the present invention relate to a plasma diagnostic apparatus that measures optical signals emitted from inside of plasma and monitors a plasma process, and/or a method thereof.

2. Description of the Related Art

OES (Optical Emission Spectroscopy) is widely used for monitoring, such as EPD (End Point Detection), during a plasma etching process. The most significant feature of OES is monitoring reactive species that are highly sensitive to a particular process. In general, such reactive species are by-products of an etching reaction; since wavelength decomposition through OES is possible, particular reactive species can be monitored. However, since OES is widely used for a plasma etching process, an overall feature of plasma and vacuum chamber is monitored; therefore, sensitivity in monitoring such particular reactive species is reduced.

Therefore, such a method to diagnose plasma is limited in use, since the sensitivity during a microscopic process, such as EPD, is reduced. Lately, numerous measures to increase the sensitivity of a monitoring are being researched. For example, if etching on a very small open area, the by-products of an etching reaction are very few; therefore, the sensitivity must be increased. However, a plasma diagnostic method, including OES, currently used for a conventional etching process is limited in increasing sensitivity. As a result, a new method of monitoring plasma with high sensitivity during a plasma process that includes EPD is desired.

### SUMMARY

Therefore, it is an aspect of the present disclosure to provide a plasma diagnostic apparatus and/or a method thereof capable of monitoring a plasma process with high sensitivity by measuring optical signals emitted from a wafer level.

Additional aspects of the disclosure will be set forth in part in the description that follows and, in part, will be obvious from the description, or may be learned by practice of the disclosure.

In accordance with an example embodiment, a plasma diagnostic apparatus includes a vacuum chamber unit, a bias power unit, a spectrum unit, a light detection unit and a control unit. The vacuum chamber unit has at least one electrode, and the vacuum chamber unit is configured to generate plasma. The bias power unit disposed inside the vacuum chamber unit is configured to apply a radio frequency voltage to an electrode that supports a wafer. The spectrum unit is configured to decompose light emitted from inside the plasma according to wavelengths. The light detection unit is configured to detect the light decomposed according to wavelengths. The control unit is configured to control a turn-on and turn-off process of the light detection unit according to a waveform of the radio frequency voltage.

The control unit is configured to control the turn-on and turn-off process of the light detection unit using a gate signal, and the gate signal has a period equal to half-period of the radio frequency voltage.

The control unit is configured to control a time delay of the gate signal according to a phase difference between the radio frequency voltage and an optical flux, the phase difference is detected by the light detection unit.

The control unit is configured to control the light detection unit to maintain a turn-on status for a given period of time when the light flux detected by the light detection unit has a maximum amplitude according to the time delay of the gate signal.

The light detection unit includes a charge coupled device and the light detection unit is configured to measure an intensity of an optical signal detected by the light detection unit through the charge coupled device.

The spectrum unit includes a diffraction grating and the spectrum unit is configured to decompose the light emitted from inside the plasma through the diffraction grating according to wavelengths.

The light reception unit includes image optical fiber and the light reception unit is configured to decompose the light emitted from inside the plasma through the image optical fiber according to a vertical space distinction.

The light reception unit includes a telecentric lens and the light reception unit is configured to convert the light emitted from inside of the plasma to a parallel light through the telecentric lens.

The radio frequency voltage has a frequency of about 13.56 Mhz, 27.12 Mhz, or 40.68 Mhz.

The radio frequency voltage is applied to the electrode that supports the wafer through an impedance matching unit configured to match an impedance of the bias power unit to an impedance of the vacuum chamber unit.

The vacuum chamber unit includes an electrode, to which a source voltage is applied, and the vacuum chamber unit is configured to generate plasma between the electrode supporting the wafer and the electrode having the source voltage applied thereto.

The vacuum chamber unit includes a dielectric window and the dielectric window has an induction coil to which a source voltage is applied so that plasma is generated between the electrode supporting the wafer and the dielectric window.

In accordance with another example embodiment, a plasma diagnostic method is as follows. The method includes generating plasma inside a vacuum chamber unit having at least one electrode while applying a radio frequency voltage to an electrode through a bias power. The electrode is disposed inside the vacuum chamber unit to support a wafer. The method includes decomposing light emitted from inside the plasma through a spectrum unit according to wavelengths. The method also includes detecting the light decomposed according to wavelengths through a light detection unit while controlling a turn-on and turn-off process of the light detection unit according to a waveform of the radio-frequency voltage.

The detecting the light decomposed according to wavelengths includes controlling the turn-on and turn-off process of the light detection unit by use of a gate signal and the gate signal has a period equal to half-period of the radio frequency voltage.

The detecting the light decomposed according to wavelengths includes controlling a time delay of the gate signal according to a phase difference between the radio frequency voltage and an optical flux, which is detected by the light detection unit.

The detecting the light decomposed according to wavelengths includes controlling the light detection unit according to the time delay of the gate signal to maintain a turn-on status for a period of time when the light flux detected by the light detection unit has a maximum amplitude.

The detecting the light decomposed according to wavelengths includes measuring an intensity of a differential signal through a difference between an average of at least one optical signal intensity, which is obtained by measuring at least once when the light flux detected by the light detection unit is maximum, and an average of at least one optical signal intensity, which is obtained through measuring at least once when the light flux detected by the light detection unit is minimum.

The light detection unit includes a charge coupled device and the detecting the light decomposed according to wavelengths includes measuring an intensity of an optical signal detected by the light detection unit through the charge coupled device.

The spectrum unit includes a diffraction grating and the decomposing light emitted from inside the plasma includes decomposing the light emitted from inside the plasma through the diffraction grating according to wavelengths.

The plasma diagnostic method further includes collecting and inducing the light emitted from inside the plasma to the spectrum unit.

In the collecting and inducing of the light emitted from inside the plasma to the spectrum unit, the light emitted from inside the plasma is decomposed according to a vertical space distinction through an image optical fiber.

In the collecting and inducing of the light emitted from inside the plasma to the spectrum unit, the light emitted from inside of the plasma is converted to a parallel light through a telecentric lens.

The radio frequency voltage has a frequency of about 13.56 Mhz, 27.12 Mhz, or 40.68 Mhz.

The radio frequency voltage is applied to the electrode supporting the wafer if an impedance of the vacuum chamber is matched to an impedance of a bias power source that is configured to supply the radio frequency voltage.

The vacuum chamber unit includes an electrode, to which a source voltage is applied, and generates plasma between the electrode supporting the wafer and the electrode having the source voltage applied thereto.

The vacuum chamber unit includes a dielectric window, and the dielectric window has an induction coil to which a source voltage is applied so that plasma is generated between the electrode supporting the wafer and the dielectric window.

According to an embodiment of the present disclosure, by attaining a difference between an optical signal emitted from a bright sheath and an optical signal emitted from a dark sheath, an optical signal emitted only from a sheath, from a wafer level, can be measured. In addition, by measuring the optical signal emitted from a wafer level, particular reactive species that are highly sensitive to a particular process can be monitored; and therefore, an accurate end point of etching during a LCD process or a semiconductor process can be determined.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a view schematically illustrating an example of a dual frequency capacitively coupled plasma source reactor.

FIG. 2 is a view schematically illustrating an example of an inductively coupled plasma source reactor.

FIG. 3 is a graph schematically illustrating an example of an excitation rate of an electron according to a distance from an electrode that is provided with a radio frequency in a plasma source reactor.

FIG. 4 is a view schematically illustrating an example of a plasma diagnostic apparatus according to an example embodiment.

FIGS. 5A to 5C are views schematically illustrating an example of a method of measuring optical signals emitted from inside of plasma according to an example embodiment.

FIG. 6 is a view schematically illustrating an example of a method of controlling gate signals according to an example embodiment.

FIG. 7 is a flow chart schematically illustrating an example of a plasma diagnostic method according to an example embodiment.

FIGS. 8A to 8C are graphs schematically illustrating an example of an optical signal that is measured after decomposed by wavelengths at a dual frequency capacitively coupled plasma source reactor according to an example embodiment.

FIGS. 9A to 9C are graphs schematically illustrating an example of differential signals measured at a dual frequency capacitively coupled plasma source reactor according to an example embodiment.

FIGS. 10A and 10B are graphs schematically illustrating an example of an optical signal that is measured after decomposed by the vertical space distinction at a dual frequency capacitively coupled plasma source reactor according to an example embodiment.

### DETAILED DESCRIPTION

Reference will now be made in detail to example embodiments of the present disclosure, example embodiments that are illustrated in the accompanying drawings, wherein like reference numerals refer to like elements throughout.

An etching can be largely divided into a dry etching and a wet etching. A wet etching is a method used for selectively removing a substance using a reactive solution. Such a wet etching can achieve an isotrope etching having the same etching speed in a vertical direction and a horizontal direction.

If a wet etching uses reactive gas or steam, an isotrope etching is achieved as in dry etching. However, if a dry etching uses gas or ion decomposed by plasma, an anisotropy is used. If a plasma etching, unlike isotrope having the same speed in a direction x (a side direction) and in a direction z (a bottom direction), the speed of the etching in a direction z is faster than that of the etching in a direction x, that is, anisotropy.

A plasma etching that can obtain anisotropy is a significant element in patterning of a semiconductor and is advantageous in determining an end point of an etching through characteristic change of plasma, in addition to including a vertical etching that can accurately move a mask pattern. According to the present disclosure, if a plasma etching is conducted on a wafer, an end point of the etching can be accurately determined by monitoring particular reactive species that are sensitive to a wafer level process.

A plasma etching process generates reactive species by using plasma, and such reactive species are used in etching at least one thin film on a surface of a wafer. In an etching process, an etch rate, anisotropy, and selectivity are highly significant variables, and in order to achieve high etch rate and an anisotropy etching, an ion flux of high energy needs to be incident on a wafer. The energy of an ion can vary from 10 eV to 1000 eV depending on an etching process.

Therefore, an etching process apparatus is expected to incident an ion flux of high energy on a wafer, and a DF CCP (Dual Frequency Capacitively Coupled Plasma) source reactor and an ICP (Inductively Coupled Plasma) source reactor are mainly used. The present disclosure can be applied to a plasma source reactor, such as the above-mentioned etching process apparatuses, which uses at least one electromagnetic power.

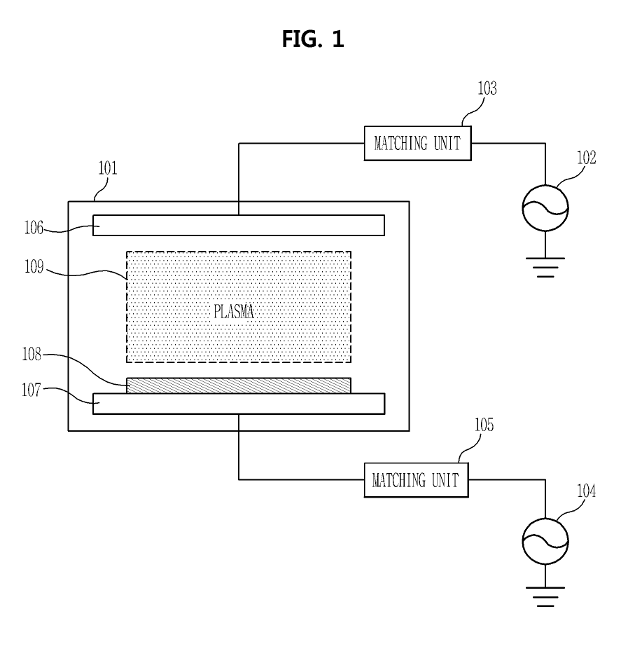

FIG. 1 is a view schematically illustrating an example of a dual frequency capacitively coupled plasma source reactor.

Referring to FIG. 1, a dual frequency capacitively coupled plasma source reactor includes a vacuum chamber unit 101 where plasma is generated from, a source power unit 102 that supplies a source voltage, a bias power unit 104 that supplies a bias voltage, an upper electrode 106, and a lower electrode 107.

A source voltage, which is provided to the upper electrode 101 by the source power unit 102, not only generates and maintains plasma 109, but also controls an ion flux that incidents on a wafer 108. A source voltage supplied by a source power unit 102 is provided to an electrode through an impedance matching unit 103, and generates capacitively coupled plasma inside the vacuum chamber unit 101. An electric field is generated between the upper electrode 106 and the lower electrode 107, and reactive gas, after being vitalized by the electric field, is generated in a state of plasma.

Plasma is generated through a process of delivering energy to electrons by accelerating electrons with an electric field, and also through an ionization as a result of a collision of atomic gas and gas molecules. For example, a small amount of electrons in reactive gas are accelerated toward the upper electrode 101 by an electric field, collided onto atomic gas that is neutral, and dissociated into an electron and ion. The dissociated electron and existing electron accelerate further dissociate atomic gas that is neutral. As such ionization continues to occur, plasma mixed with electron, ion, and neutral atomic gas is generated. In addition, a plasma etching on a substrate 108 is achieved by the plasma generated inside the vacuum chamber unit 101.

The vacuum chamber unit 101 is manufactured using metallic substances, such as aluminum, stainless steel, copper, etc. In addition, the vacuum chamber unit 101 may be manufactured using coated metals, such as anodic treatment aluminum, nickel-plated aluminum, or fireproof metals. The metallic substances which form the vacuum chamber unit 101 are not limited hereto, the vacuum chamber unit 101 may be manufactured using various substances that are appropriate to perform a plasma process. The internal pressure of the vacuum chamber unit 101 may vary from a number of mT to hundreds of mT.

A gas supply unit (not shown) is equipped at an upper portion of the upper electrode 101 and supplies reactive gas into the vacuum chamber unit 101 through a gas inlet hole (not shown).

The reactive gas remaining after a plasma etching is emitted through a gas outlet hole (not shown) formed at the vacuum chamber unit 101, and a gas pump is connected to the gas outlet unit in order to emit reactive gas outside the vacuum chamber unit 101.

The lower electrode 107 is formed in an opposing direction to the upper electrode 101. The substrate 108, which may be supported by the lower electrode 107, for example, may be a wafer substrate but is not limited hereto. For example, the substrate 108 may be a wafer substrate, a glass substrate or a plastic substrate for manufacturing a semiconductor apparatus, a display apparatus, a solar battery, etc.

A bias voltage, which is provided to the lower electrode 107 by the bias power unit 104, not only controls ion energy inside of the plasma 109, but also provides ion flux of high energy that incidents the substrate 108. The bias voltage supplied by the bias power unit 104 is provided to the lower electrode 107 via an impedance matching unit 105.

A source voltage that is provided by the source power unit 102 has a relatively higher frequency, while a bias voltage that is provided by the bias power unit 104 has a relatively lower frequency. For example, the source power unit 102 may use a frequency in a range of 27 Mhz to 40 Mhz or may use a range of 60 Mhz to 160 Mhz as a higher frequency, while a bias power unit 104 may use lower frequencies of 0.4, 1, 2, or 13.56 Mhz. The upper electrode 101 is made to run at a relatively higher frequency, while the lower electrode 102 is made to run on at a relatively lower frequency. Each of the plurality of electrodes 106 and 107 is run by a different radio frequency voltage that is provided from each of the plurality of power unit 102 and 104, respectively, and induces capacitively coupled plasma inside the vacuum chamber unit 101.

The upper electrode 106 and the lower electrode 107, as illustrated in FIG. 1, may have a plate type structure but is not limited thereto. Various structures such as a circular type structure, an oval type structure, a polygonal type structure, etc. may be included.

The dual frequency capacitively coupled plasma source reactor may further include a circuit distribution unit (not shown) that may evenly distribute different radio frequency voltages provided by a plurality of power units 102 and 104 to a plurality of electrodes 106 and 107. The circuit distribution unit is composed of a current equilibrium circuit and creates a reciprocal balance among the current provided to a plurality of electrodes 106 and 107. As a result, a plurality of electrodes 106 and 107 create a balance in currents, and may uniformly generate and maintain large-scale plasma.

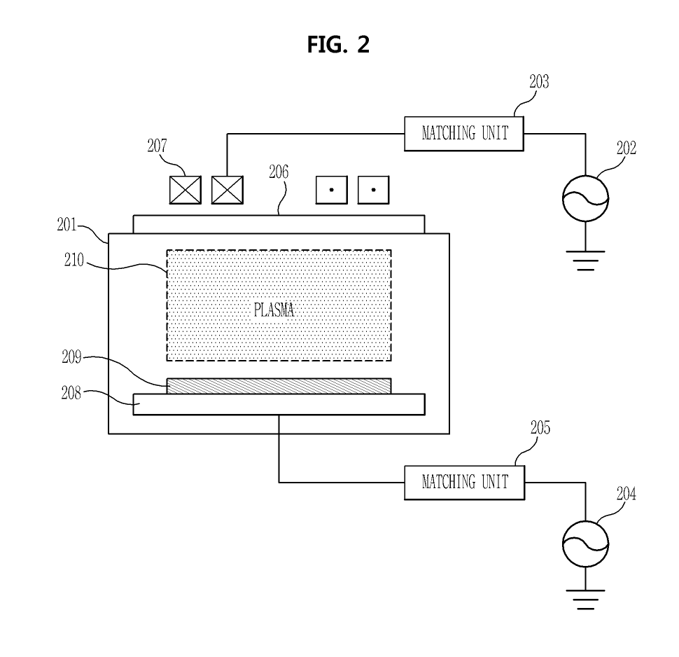

FIG. 2 is a view schematically illustrating an example of an inductively coupled plasma source reactor.

Referring to FIG. 2, an inductively coupled plasma source reactor includes a vacuum chamber unit 201 in which plasma is generated, a source power unit 202 that supplies a source voltage, a bias power unit 204 that supplies a bias voltage, a dielectric window 206 that serves as an upper electrode, and a lower electrode 208 that supports a substrate 209. In describing the inductively coupled plasma source reactor, components identical to those of the dual frequency capacitively coupled plasma source reactor of FIG. 1 will be omitted in order to avoid redundancy.

The vacuum chamber unit 201 maintains a vacuum state, and the internal pressure may be in a range of a number of mT and hundreds of mT. The vacuum chamber unit 201 may be manufactured using various substances that are appropriate to perform a plasma process. The vacuum chamber unit 201 includes a gas supply unit (not shown) and reactive gas flows into the vacuum chamber unit 201 through a gas inlet hole (not shown).

The reactive gas remaining after a plasma process is completed is emitted through a gas outlet hole (not shown) formed at the vacuum chamber unit 201, and a gas pump is connected to the gas outlet hole to emit reactive gas outside the vacuum chamber unit 201.

Plasma 210 is generated by a source voltage supplied by the source power unit 202, and ion energy of plasma 210 is controlled by a bias voltage supplied by the bias power unit 204. A source voltage supplied by the source power unit 202 may have a relatively high frequency in comparison to a bias voltage supplied by the bias power unit 204.

The lower electrode 208 is formed in an opposing direction of the dielectric window 206, and the substrate 209 supported by the lower electrode 208 may be a wafer substrate, for example.

The dielectric window 206 is formed at an upper portion to the vacuum chamber unit 201 and an induction coil 207 is equipped at an outside surface of the upper portion of the dielectric window 206. The dielectric window 206 insulates between the induction coil 207 and the vacuum chamber unit 201 and the induction coil 207 is positioned to form a ring shape around and following the outer surface of the upper portion of the dielectric window 206. The induction coil 207 may, for example, include copper.

The source power unit 202 applies a source voltage to the induction coil 207 through an impedance matching unit 203. A current flows in the induction coil 207 due to the source voltage and an electric field is generated inside the vacuum chamber unit 201 due to the current flowing in the induction coil 207. The plasma 210 is generated as a result of a collision of atomic gas and gas molecules that are accelerated by the electric field induced inside the vacuum chamber unit 201. For example, the plasma 210 is generated in the vacuum chamber unit 201 between the dielectric window 206 and the electrode 208.

The bias power unit 204 applies a bias voltage to the lower electrode 208 through the impedance matching unit 205. The induced plasma 210 moves toward the substrate 209 by the electric field generated by a bias voltage that is applied to the lower electrode 208, and performs an etching on an exposed portion of the substrate 209.

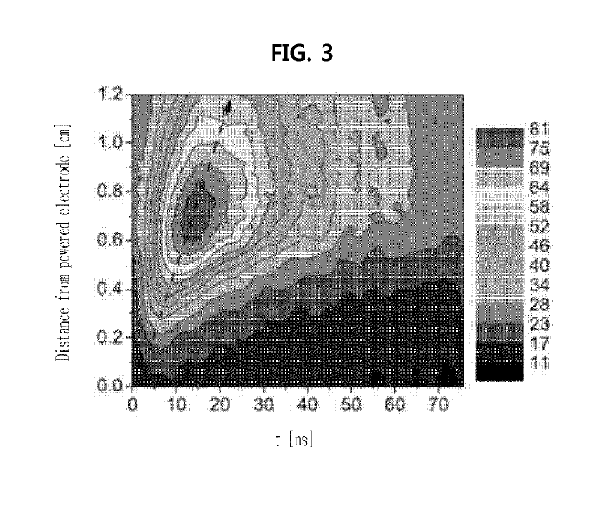

Referring to FIG. 2 and FIG. 3, a frequency having a lower bias voltage or a higher voltage is applied to an electrode at every plasma source reactor. A role of a bias voltage is to generate a sheath on a substrate. The most significant characteristic of a bias voltage is to cause a voltage drop on the sheath, as the voltage drop on the sheath may control ion energy that incidents on a substrate. In the etching process, ion energy of a broad range of 10 eV to 1000 eV is used. For example, if a process needs a high ion energy, a voltage drop on a sheath needs to be huge and a thickness of a sheath needs to be thick.

A sheath is formed around a substrate that makes contact with plasma. A sheath may be defined as a boundary between plasma and a substrate; for example, an area in which plasma is separated from the substrate. Plasma is electrically neutral as the number of electrons and the number of ions are the same. However, as a transfer of negative charge is accumulated on an electrode, electrons are forced out from the electrode while ions are pulled in, creating an area where the number of ions is greater than the number of electrons around the electrode. Electrons are exponentially decreased in number while nearing an electrode by a potential difference between the electrode and plasma, and ions are linearly decreased while nearing the electrode as ions are accelerated in the process of being pulled in. An area accumulated with more positive charges than negative charges is formed in terms of a volume per unit, and the area becomes a dark space as less ionization takes place due to fewer number of electrons as a result of being in a non-plasmic area. For example, the density of electrons is exponentially decreased in numbers while nearing a substrate, so the amount of light emitted from ionization and excitation is small. Accordingly, the area is darker than an area with plasma.

FIG. 3 is a graph schematically illustrating an example of an excitation rate of an electron according to a distance from an electrode that is given with a radio frequency in a plasma source reactor.

Referring to FIG. 3, an excitation rate of an electron measured with OES (Optical Emission Spectroscopy) may be checked. By measuring the light emitted from plasma bulk and by monitoring a particular wavelength, OEA may be used for estimating a process change, such as EPD (End Point Detection), etc. However, OES has a limitation in diagnosing plasma since an optical signal measured by OES is an optical signal that may be emitted from a sheath or from a pre-sheath, not only from plasma bulk.

In FIG. 3, an excitation rate of an electron of krypton at a distance of 1.2 cm from an electrode is shown. An arrow indicates a trait and a movement of a modulated sheath. For example, an area of a sheath expands while shaking toward a vertical direction according to the waveform of a radio frequency voltage applied to a lower electrode.

Accordingly, there is a need for a diagnostic method for diagnosing whether the optical signal is emitted from a sheath or from plasma bulk. For such method, wavelength resolution as well as spatial resolution of OES is required, since optical signals having different wavelengths represent different spatial characteristics from each other. For example, according to a wavelength, optical signals of some wavelength are mostly excited at a sheath while other light signals are mostly excited at plasma bulk.

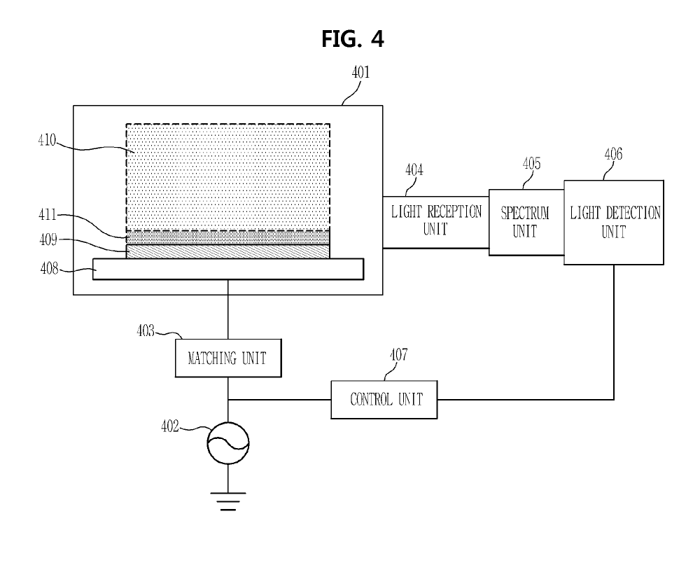

FIG. 4 is a view schematically illustrating an example of a plasma diagnostic apparatus according to an example embodiment.

A plasma diagnostic apparatus includes a vacuum chamber unit 401, a light reception unit 404, a spectrum unit 405, a light detection unit 406, a bias power unit 402, and a control unit 407. In describing the plasma diagnostic apparatus according to the embodiment of the present disclosure, components identical to those of the dual frequency capacitively coupled plasma source reactor of FIG. 1 and the inductively coupled plasma source reactor of FIG. 2 will be omitted in order to avoid redundancy.

Although not illustrated on FIG. 4, the plasma diagnostic apparatus may include a source power unit and the source power unit may be used for generating plasma and dissociating ion. A plasma source reactor, to which the plasma diagnostic apparatus is applied, is not limited to the dual frequency capacitively coupled plasma source reactor and the inductively coupled plasma source reactor. The plasma diagnostic apparatus may be applied to other source reactors using a bias power.

The vacuum chamber unit 401 is provided at an inner portion with at least one electrode 408. The electrode 408 supports a substrate 409 while receiving a radio frequency voltage from the bias power unit 407. The substrate 409 may include a wafer substrate, a glass substrate, a plastic substrate, etc.

A bias power unit 407 applies a radio frequency voltage to the electrode 408. The radio frequency voltage is used to modulate a plasma sheath 411. The radio frequency voltage applied by the bias power unit 407 is a relatively lower voltage, and may have a voltage at one of the following frequencies: 13.56 Mhz, 27.12 Mhz, and 40.68 Mhz. A radio frequency voltage supplied by a bias power unit 407 is applied to the electrode 408 through an impedance matching unit 403. The impedance matching unit 403 matches an impedance of the vacuum chamber unit 401 to an impedance of the bias power unit 407. The impedance matching unit 403 serves to protect the bias power unit 407 and deliver a power voltage supplied from the bias power unit 407 to inside of the plasma.

The present disclosure is to measure optical signals emitted from a nearby area of the substrate 409 and to selectively measure a particular wavelength that is sensitive to variables of a process change in a process, such as EPD. According to the present disclosure, the plasma sheath 411 is modulated if a bias voltage is provided to incident high ion energy on the substrate 409.

The vacuum chamber unit 401 may include a view port to monitor a plasma process. For example, the light reception unit 404 may receive an optical signal emitted from plasma through the view port. The light reception unit 404 collects and induces the emitted light from plasma to the spectrum unit 405. The light reception unit 404 may include an image optical fiber and the image optical fiber may decompose the light emitted in plasma according to vertical space distinction in a level of the substrate 409. The image optical fiber may include a number of strips and is an optical fiber that enables a total reflection of the light penetrating a center unit of a glass. In addition, the light reception unit 404 may include a telecentric lens and through the telecentric lens, the light emitted from inside of the plasma may be converted into a parallel light. As a result, the light reception unit 404 decomposes and induces the light emitted from an inside of plasma to the spectrum unit 405 after decomposing the light according to vertical space distinction.

The light emitted from inside of the plasma sheath 411 is measured by a combination of the spectrum unit 405 and the light detection unit 406 where a turn-on and a turn-off is controlled.

The light detection unit 406, for example, may include a CCD (Charge Coupled Device). For example, the light detection unit 406 may measure the intensity of an optical signal through the CCD. The intensity of an optical signal is measured based on the amount of charges generated according to the intensity of a light through the CCD. The light detection unit 406 may be equipped with a photo diode array but is not limited hereto, any device that measures the intensity of light may be equipped.

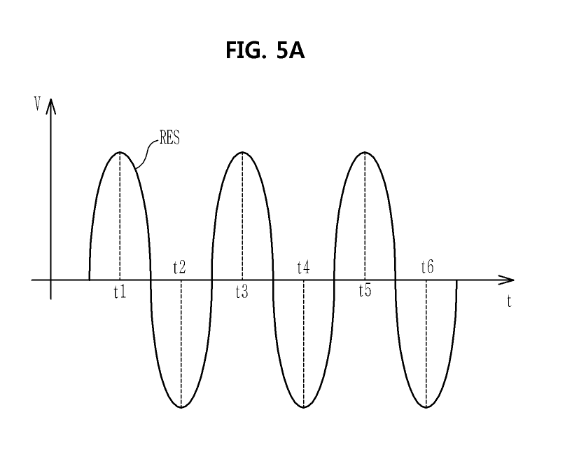

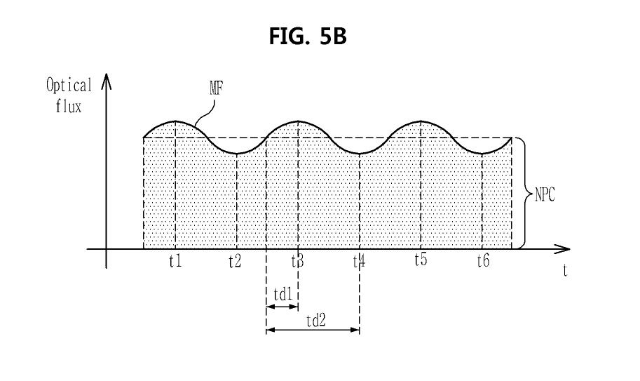

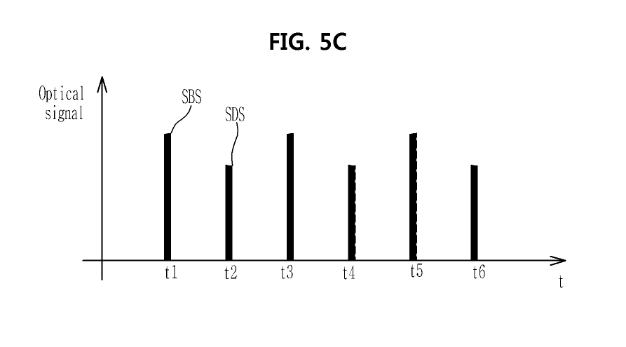

The control unit 407 controls a turn-on and a turn-off of the light detection unit 406 by using a gate signal, according to a waveform of a radio frequency that is applied to the electrode 408. By using a gate signal, an optical signal emitted from the sheath 411 is separated from an optical signal emitted from a plasma bulk 410 area. A method of controlling the light detection unit 406 at the control unit 407 will be explained in detail with reference to FIGS. 5A to 5C.

The spectrum unit 405 is equipped with a diffraction grating and may decompose the light emitted from inside of the plasma through the diffraction grating according to wavelength. For example, a wavelength component emitted from a sheath 411 area may be selectively measured using a wavelength resolution by the diffraction grating. The diffraction grating is a minor with microscopic slots regularly carved onto. Two types of diffraction gratings are possible. For example, a mechanical grating has slots mechanically carved onto and a holographic grating is obtained by etching after patterning using a photoresist. A wavelength resolution may vary by the number of slots carved onto per a unit area (mm), and the degree of spectrum resolution increases as more slots are carved. If a light incidents on a diffraction grating, a parallel light needs to be incident, and, as described above, the light emitted from plasma is converted into a parallel light through a telecentric lens.

A wavelength component of an optical signal, which is normally emitted from the sheath 411 while converted by a frequency of a bias voltage, may be defined as an S-line (Surface line). Since a S-line is emitted from the sheath 411 that is near the substrate 409, the S-line is considered to be most sensitive to a process of a wafer level.

A method of measuring a modulated optical signal by use of the light detection unit 406 is as follows. For example, the present disclosure provides a method of measuring an optical signal modulated by a bias voltage to incident high ion energy onto a wafer substrate in a plasma source reactor.

An optical signal emitted from the sheath 411 changes within a frequency range of a bias power according to a movement of the sheath 411. Such a movement of the sheath 411 may be divided into two cases; for example, a point in time when a thickness of the sheath 411 reaches a maximum, and a point in time when a thickness of the sheath 411 reaches a minimum. The point in time when a thickness of the sheath 411 reaches a maximum corresponds to a case of a dark sheath in which electrons are scarce, and the point in time when a thickness of the sheath 411 reaches a minimum corresponds to a bright sheath in which electrons are abundant.

The point in time when a thickness of the sheath 411 reaches a minimum, ideally when the thickness reaches 0, is considered a collapse of a sheath defined when an electron current flows rapidly to the wafer substrate 409. Such a rapid flow of an electron current is needed to neutralize an ion current that flows on the wafer substrate 409 within a frequency range of a bias power as the total current flowing on the wafer substrate 409 within a frequency range of a bias power needs to 0. Such a flow of an electron current causes an additional light emission during a short period of time when the amount of electrons in the sheath 411 is sufficient.

FIGS. 5A to 5C are views schematically illustrating an example of a method of measuring optical signals emitted from inside of plasma according to an example embodiment.

Referring to FIG. 5A, the frequency of a RES (Reference Electrical Signal) corresponds to the frequency of a radio frequency voltage that is applied to the bias power unit.

When the optical signals emitted from inside of the plasma is continuously measured, an optical signal emitted from a plasma bulk while being slightly modulated is simultaneously measured together with an optical signal emitted from a sheath while being highly modulated. Therefore, according to the mathematical formula 1 below, a differential signal is obtained through the difference in optical signals emitted from a dark sheath and a bright sheath:

Idif=Ib−Id

Idif=const*Ish, where const<2 [Mathematical Formula 1]

From the mathematical formula 1, Ib represents the optical signal emitted from a bright sheath and Id represents the optical signal emitted from a dark sheath, while Idif represents the differential signal.

A differential signal Idif is in proportion to an optical signal Ish that is emitted only from a sheath. Const is a constant that may vary according to a time delay caused by the phase difference between a radio frequency voltage of a bias power corresponding to RES and a modulated optical flux. For example, when a time delay is a variable, the differential signal is adjusted to have a maximum value while changing the time delay. For example, a time delay of a gate signal, which is used to control a turn-on and a turn-off of the light detection unit, is adjusted such that the light detection unit is controlled to be turned on for a predetermined period of time when the optical flux has a maximum amplitude.

Referring to the graph of FIG. 5B, an optical flux emitted from inside of the plasma may be shown. When a source power and a bias power are applied to the electrode during a plasma etching process, plasma areas that show different tendencies are present on a wafer substrate: a plasma bulk area and a sheath area. The characteristics of the optical signals emitted from the two areas are different; the optical signal emitted from a plasma bulk area is relatively stable while the optical signal emitted from a sheath area is modulated by a frequency of a bias power. For example, a MF (Modulated Flux) that is emitted after being modulated from inside of the plasma, as shown in the graph of FIG. 5B, moves vertically according to the frequency of a bias power while maintaining a NPCL (Neutral Plasma Constant Level).

Such a phenomenon occurs due to the inflow/outflow of electrons to inside/outside a sheath while a sheath area is shaken vertically according to the frequency of a bias voltage. For example, as the electrons inside of the plasma collide with neutral atomic gas and molecules in plasma, the neutral atomic gas and molecules are excited, and the neutral atomic gas and molecules are stabilized to a ground state, emitting light. If no electron is present in a sheath, the optical signal emitted from a sheath area is less, and the optical signal emitted from a sheath area is more if a sufficient number of electrons are in a sheath. As describe above, the changes in optical signals emitted from inside of the sheath corresponds to the frequency of a bias power, for example, the frequency of RES.

The light emitted from inside of the sheath is modulated by the frequency of a bias power voltage by its nature. Accordingly, the light emitted from a sheath area is distinguished from the light emitted from a plasma bulk area since the optical signal emitted from a plasma bulk area is only slightly modulated by the frequency of a bias power. In addition, a sheath is positioned at the closest location to a wafer substrate inside a vacuum chamber; therefore, the optical signal emitted from a sheath area is most sensitive to a wafer level process. This indicates that the reactive species emitted from a wafer substrate, for example, the by-products from an etching reaction are measured close to a wafer substrate. As a result, by measuring the optical signal emitted from the sheath area modulated by a frequency of a bias power, reactive species sensitive to a wafer level process may be measured.

Referring to FIG. 5C, the point of time to measure the optical signal emitted from inside of the plasma by controlling a turn-on and a turn-off of a light detection unit is indicated. The time interval of the gate signal needs to be much shorter than the period corresponding to a frequency of a bias power. For example, if a frequency of the bias power is 2 Mhz, the period is 500 ns, and therefore, the time interval of the gate signals may be set at 70 ns. In order to obtain a differential signal, the optical signals from a bright sheath and a dark sheath need to be measured. Measuring is possible by setting the period of the gate signal to be at a half-period of the RES, for example, a radio frequency supplied by a bias power.

During the time period of the first gate pulse, the optical signal emitted from a bright sheath, SBS (Signal of Bright Sheath) is measured, and during the time period of the second gate pulse, the optical signal emitted from a dark sheath, SDS (Signal of Dark Sheath) is measured. A differential signal may be obtained through the difference of the two optical signals, thereby obtaining an optical signal, which is modulated by a frequency of a bias power. If the phase of the RES is matched to the phase of the modulated optical flux, optical signals corresponding to a time when the amplitude of the RES is at a maximum (t1 to t6) are measured, thereby measuring optical signals corresponding to a time when the amplitude of the modulated optical flux is at a maximum (t1 to t6).

In FIG. 5C, a gate pulse enables the light detection unit to be turned on in nanoseconds and the time delay of a gate signal used to control the light detection unit is controlled based on the point of time when the amplitudes of the optical flux is at a maximum and at a minimum. In order to measure a optical signal emitted from a bright sheath and a dark sheath, the intensity of an optical signal when the modulated optical flux is at a maximum is measured at least once to obtain the average value of the intensity of the optical signal, and then the intensity of an optical signal when the modulated optical flux is at a minimum is measured at least once to obtain the average value of the intensity of the optical signal. The intensity of a differential signal is measured through the difference between the average values.

Referring to FIG. 5B, a time delay (td1) used to measure an optical signal emitted when the amplitude of the optical flux is at a maximum corresponds to ¼ period of the amplitude of the modulated optical flux. A time delay (td2) used to measure an optical signal emitted when the amplitude of the optical flux is at a minimum corresponds to ¾ period of the amplitude of the modulated light. This time delay is set based on the point in time when a sheath is modulated when a radio frequency voltage generated by a bias power is applied to a lower electrode.

As described above, as long as the plasma bulk is not modulated by a bias power, the differential signal measured by a light detection unit is directly in proportion to the optical signal emitted from a sheath.

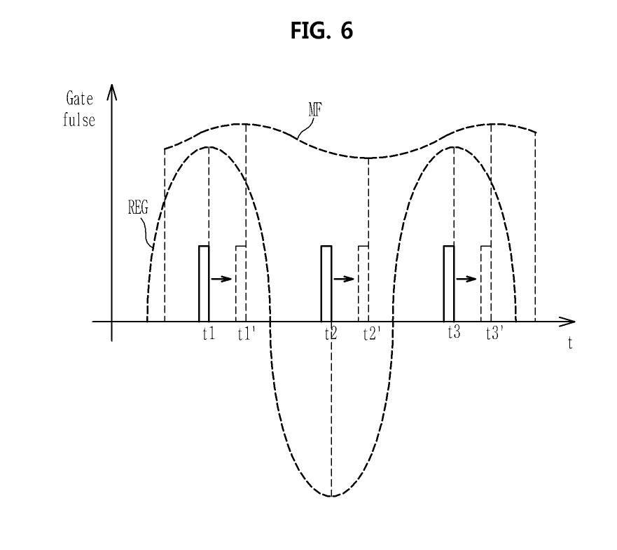

FIG. 6 is a view schematically illustrating an example of a method of controlling gate signals according to an example embodiment.

Referring to FIG. 6, a case is illustrated when the phase of the reference electric signal (RES) and the phase of modulated optical flux (MF) do not coincide. Although a light detection unit is controlled to be turned on at the time when the amplitude of the RES is at a maximum (t1 to t3) according to the gate pulse, the optical signal emitted from plasma at the time when the amplitude of MF is at a maximum (t1 to t3) is not measured.

Therefore, a gate pulse needs to be delayed according to the phase difference between REF, for example, the radio frequency voltage supplied by a bias power unit, and MF modulated by a bias power. For example, the time delay, as described above, not only represents the time delay needed to detect optical signals starting from the point in time when the optical flux emitted from plasma is modulated by a bias power, but also represents the time delay needed to measure the optical signal at the point in time when the amplitude of the modulated optical flux is at a maximum in case RES and MF are different in phase.

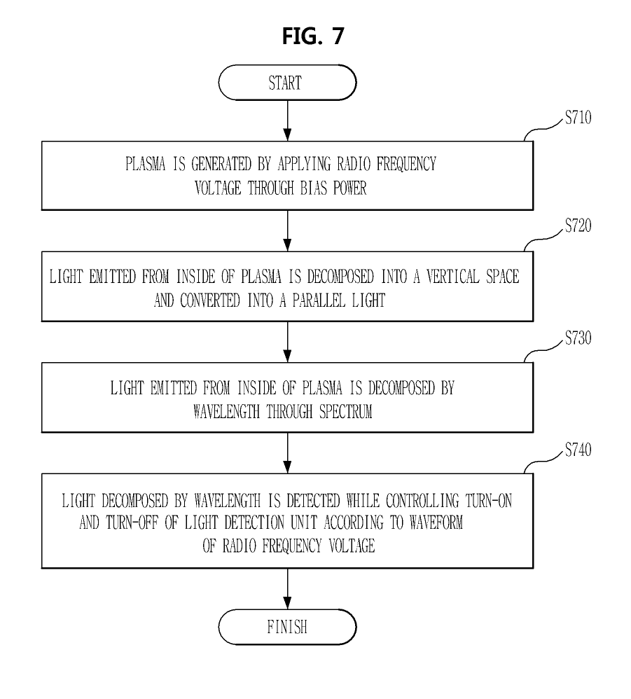

FIG. 7 is a flow chart schematically illustrating an example of a plasma diagnostic method according to an example embodiment.

Referring to FIG. 7, plasma is generated inside a vacuum chamber (710). To generate plasma a dual frequency capacitively coupled plasma source reactor or an inductively coupled plasma source reactor may be used, but example embodiments are not limited thereto. At least one electrode is to be equipped inside the vacuum chamber and a radio frequency voltage is applied to an electrode supporting a wafer through a bias power.

The voltage of the radio frequency applied to an electrode through a bias power may have frequencies of 13.56 Mhz, 27.12 Mhz, or 40.68 Mhz, and is applied while the impedance of a bias power supply source and the impedance of the vacuum chamber are matched. For example, a matching circuit may be provided between a vacuum chamber and a bias power supply source.

In addition, the light emitted from inside of plasma is decomposed according to a vertical space distinction and converted into a parallel light (720). For example, a process of collecting and inducing the light emitted from inside of plasma to a spectrum unit is required, and during this process, the light emitted from plasma may be decomposed according to a vertical space distinction through an image optical fiber, or the light emitted from plasma may be converted into a parallel light through a telecentric lens.

The light converted into a parallel light and decomposed according to a vertical space distinction is decomposed by wavelengths through a spectrum unit (730). A spectrum unit is equipped with a diffraction grating and the light entering the spectrum unit is decomposed according to wavelengths through the diffraction grating.

The light decomposed according to wavelengths is detected while a turn-on and a turn-off of a light detection unit is controlled according to the waveform of a radio frequency voltage (740). A turn-on and a turn-off of the light detection unit may be controlled using a gate signal. For example, if the optical flux detected by the optical detection unit has the same phase as that of the radio frequency voltage, the light detection unit is controlled to be turned on if the amplitude of the waveform of a radio frequency voltage is at a maximum. The period of the gate signal needs to be half-period of the waveform of the radio frequency voltage. A time delay of the gate signal may be required depending on the phase difference between the radio frequency voltage and the optical flux detected by the light detection unit. If a phase of the optical flux detected by the light detection unit is different from a phase of a radio frequency voltage, the light detection unit is controlled to be turned on for a given time length at a point of time when the amplitude of the optical flux detected by the light detection unit is at a maximum according to the time delay of the gate signal. The details of the method of controlling the light detection unit have been described with reference to FIGS. 5A to 5C.

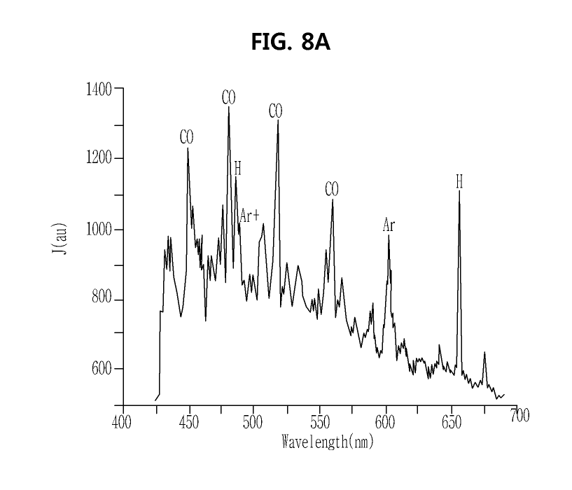

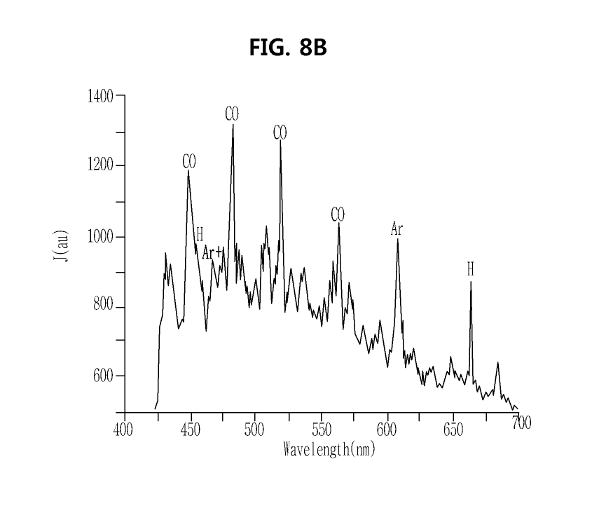

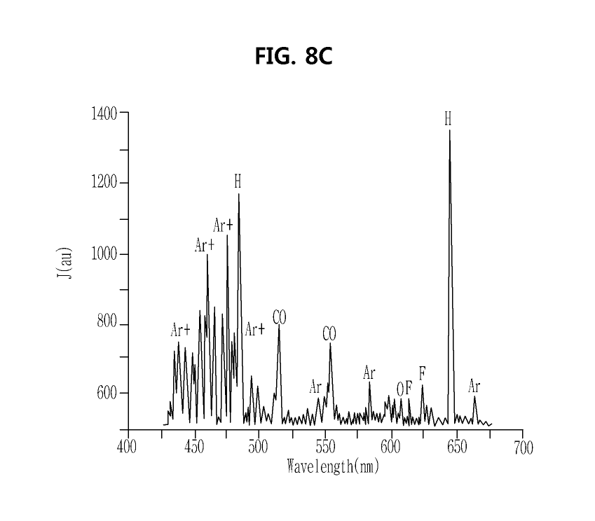

FIGS. 8A to 8C are graphs schematically illustrating an example of an optical signal that is measured after decomposed by wavelengths at a dual frequency capacitively coupled plasma source reactor according to an example embodiment.

Optical signals emitted from a bright sheath and a dark sheath are shown in FIGS. 8A and 8B, respectively, and a differential signal is shown in FIG. 8C in which plasma is discharged by using Ar, O2, and CHF3 reactive gas at a DF CCP source reactor. The wavelength spectrum of the optical signal emitted from a bright sheath of FIG. 8A appears to be similar to that of the optical signal emitted from a dark sheath of FIG. 8B while showing a significant difference from that of FIG. 8C.

The reason the graphs in FIGS. 8A and 8B look identical is because the optical signal are emitted from a plasma bulk while being slightly modulated. For example, the light signals that are emitted from a bright sheath and a dark sheath are the signals emitted from a sheath area after a plasma bulk being expanded to a sheath area. Therefore, the graphs on FIGS. 8A and 8B are identical to the spectrum of OEX that measures the optical signal emitted from a plasma bulk.

However, the differential signal spectrum of FIG. 8C is mainly formed by the optical signal emitted from a modulated sheath area. The reason the differential signal spectrum is different from the spectrum of OES that measures the optical signal emitted from a plasma bulk is because the EEDF (Electron Energy Distribution Function) in a sheath and the EEDF in a plasma bulk are different. For example, since the density of the electrons in a sheath is low, therefore an excitation cross section is low but collision is low, so excitation threshold energy is high. However the opposite tendency is shown in a plasma bulk.

FIG. 8C indicates the high sensitivity of the plasma diagnostic apparatus. For example, at the differential signal spectrum shown on FIG. 8C, active species for etching SiO2 appear, such as O, and F atomic spectrum. The O and F atomic spectrums are difficult to measure on the graphs in FIGS. 8A and 8B, which are similar to the result from a conventional OES. Ar+ lines, which are ion spectrums, are seen at the differential signal spectrum, and these lines have high excitation threshold energy that is as high as 20 eV. The graph showing lines having high excitation threshold energy with a high intensity indicates that the differential signal spectrum is mainly formed by the modulated optical signal emitted from a sheath area.

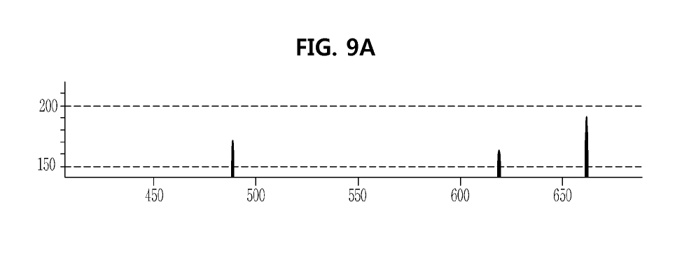

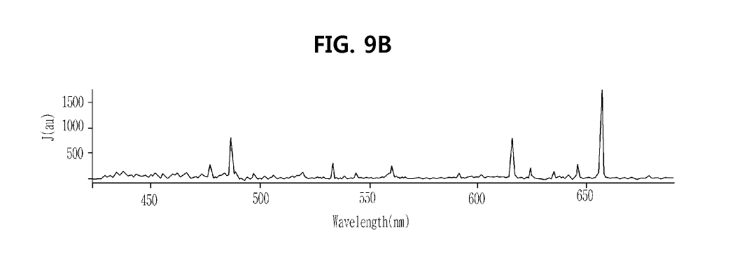

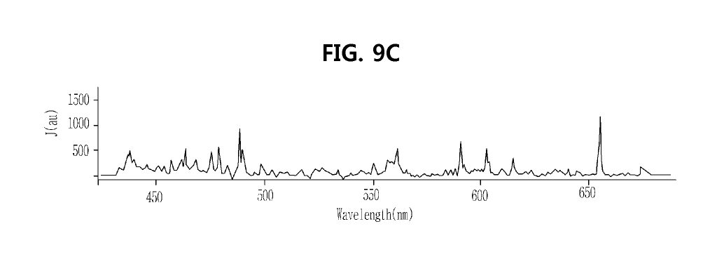

FIGS. 9A to 9C are graphs schematically illustrating an example of differential signals measured at a dual frequency capacitively coupled plasma source reactor according to an example embodiment.

FIG. 9A illustrates an image, by wavelength, of a differential signal that is measured after plasma is discharged by using Ar, O2, and CHF3 reactive gas at a DF CCP source reactor. FIG. 9B and FIG. 9C illustrates the spectrum, by wavelength, of the optical signal emitted from a different location of plasma. For example, FIG. 9B shows a spectrum of an optical signal at a position adjacent to a wafer level, and FIG. 9C shows a spectrum of an optical signal at a position of the plasma bulk.

Referring to FIGS. 9A to 9C, wavelength-specified lines emitted from a sheath area are shown. For example, the H atomic spectrum of 486 nm and 656 nm and the O atomic spectrum of 616 nm are measured as being emitted stronger at the sheath location near a wafer level, and such lines are considered to be S-lines as described above. Other lines such as Ar atomic spectrum having 591 nm and 603 nm wavelengths show different tendencies and are measured to be emitted mostly from a plasma bulk. For example, the spectrum of the optical signal emitted from a sheath area shows different characteristics according wavelengths.

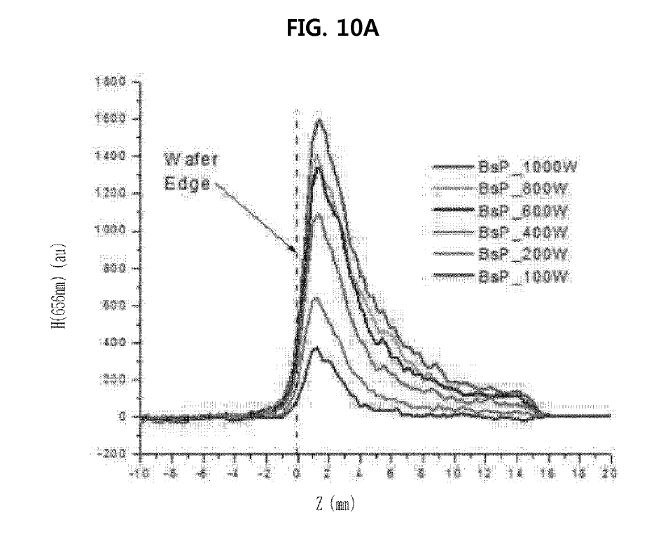

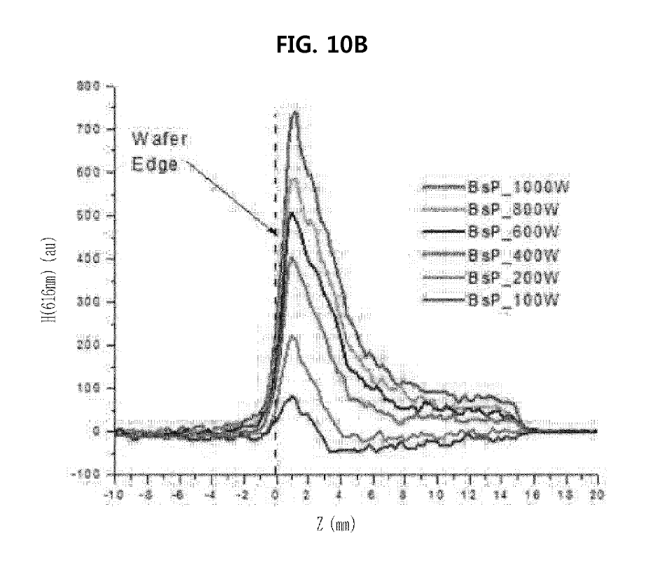

FIGS. 10A and 10B are graphs schematically illustrating an example of an optical signal that is measured after decomposed by the vertical space distinction at a dual frequency capacitively coupled plasma source reactor according to an example embodiment.

FIGS. 10A and 10B illustrate the results, among the S-lines described above, of the H atomic spectrum of 656 nm wavelength and the O atomic spectrum of 616 nm wavelength, which are spatially measured. The x axis of the graph represents a distance from where an optical signal is measured in relation to a wafer substrate, and the y axis represents the intensity of a spectrum. As the graphs on FIGS. 10A and 10B illustrate, the position where the intensity of a spectrum is a maximum is the position near a wafer level.

For example, the value of the S-line measured is a maximum when the 5-line is 1.5 mm apart from a wafer level and the result implies that the most sensitive S-line is measured by the plasma diagnostic apparatus. In addition, the magnitude of the S-line is shown to be significantly larger in the sheath area than that of the 5-line in a plasma bulk area. Therefore, most S-lines are emitted from the sheath area.

Although a few example embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A plasma diagnostic apparatus comprising:
a vacuum chamber unit having at least one electrode and configured to generate plasma;
a bias power unit disposed inside the vacuum chamber unit and configured to apply a radio frequency voltage to an electrode that supports a wafer;
a spectrum unit configured to decompose light emitted from inside the plasma according to wavelengths;
a light detection unit configured to detect the light decomposed according to wavelengths; and
a control unit configured to control a turn-on and turn-off process of the light detection unit according to a waveform of the radio frequency voltage.

2. The plasma diagnostic apparatus of claim 1, wherein the control unit is configured to control the turn-on and turn-off process of the light detection unit using a gate signal, and the gate signal has a period equal to half-period of the radio frequency voltage.

3. The plasma diagnostic apparatus of claim 2, wherein the control unit is configured to control a time delay of the gate signal according to a phase difference between the radio frequency voltage and an optical flux and the optical flux is detected by the light detection unit.

4. The plasma diagnostic apparatus of claim 3, wherein the control unit is configured to control the light detection unit to maintain a turn-on status for a period of time when the light flux detected by the light detection unit has a maximum amplitude, according to the time delay of the gate signal.

5. The plasma diagnostic apparatus of claim 1, wherein the light detection unit includes a charge coupled device and the light detection unit is configured to measure an intensity of an optical signal detected by the light detection unit through the charge coupled device.

6. The plasma diagnostic apparatus of claim 1, wherein the spectrum unit includes a diffraction grating and the spectrum unit is configured to decompose the light emitted from inside the plasma through the diffraction grating according to wavelengths.

7. The plasma diagnostic apparatus of claim 1, wherein the radio frequency voltage is applied to the electrode that supports the wafer through an impedance matching unit, the impedance matching unit configured to match an impedance of the bias power unit to an impedance of the vacuum chamber unit.

8. A plasma diagnostic method comprising:
generating plasma inside a vacuum chamber unit having at least one electrode while applying a radio frequency voltage to an electrode, the electrode disposed inside the vacuum chamber unit to support a wafer;
decomposing light emitted from inside the plasma through a spectrum unit according to wavelengths; and
detecting the light decomposed according to wavelengths through a light detection unit while controlling a turn-on and turn-off process of the light detection unit according to a waveform of the radio-frequency voltage.

9. The plasma diagnostic method of claim 8, wherein the detecting the light decomposed according to wavelengths includes controlling the turn-on and turn-off process of the light detection unit by use of a gate signal and the gate signal has a period equal to half-period of the radio frequency voltage.

10. The plasma diagnostic method of 9, wherein the detecting the light decomposed according to wavelengths includes detecting an optical flux and controlling a time delay of the gate signal according to a phase difference between the radio frequency voltage and the optical flux.

11. The plasma diagnostic method of claim 10, wherein the detecting the light decomposed according to wavelengths includes controlling the light detection unit according to the time delay of the gate signal to maintain a turn-on status for a period of time when the light flux detected by the light detection unit has a maximum amplitude.

12. The plasma diagnostic method of claim 11, wherein the detecting the light decomposed according to wavelengths includes measuring an intensity of a differential signal through a difference between an average of at least one optical signal intensity, which is obtained by measuring at least once when the light flux detected by the light detection unit is maximum, and an average of at least one optical signal intensity, which is obtained by measuring at least once when the light flux detected by the light detection unit is minimum.

13. The plasma diagnostic method of claim 8, wherein the light detection unit includes a charge coupled device and the detecting the light decomposed according to wavelengths includes measuring an intensity of an optical signal detected by the light detection unit through the charge coupled device.

14. The plasma diagnostic method of claim 8, wherein the spectrum unit includes a diffraction grating and the decomposing light emitted from inside the plasma includes decomposing the light emitted from inside the plasma through the diffraction grating according to wavelengths.

15. The plasma diagnostic method of claim 8, wherein the generating plasma includes matching an impedance of the vacuum chamber to an impedance of a bias power source that is configured to supply the radio frequency voltage and applying the radio frequency voltage to the electrode supporting the wafer.
